(19) United States
(12) Patent Application Publication
(10) Pub. No.: US 2013/0108933 A1
(43) Pub. Date: May 2, 2013

(54) Manufacture of LiPO2F2 and crystalline LiPO2F2

(71) Applicants: Placido Garcia-Juan, Hannover (DE); Alf Schulz, Wedemark (DE)

(72) Inventors: Placido Garcia-Juan, Hannover (DE); Alf Schulz, Wedemark (DE)

(73) Assignee: SOLVAY SA, Brussels (BE)

(21) Appl. No.: 13/808,242

(22) PCT Filed: Jun. 30, 2011
(86) PCT No.: PCT/EP11/61030

§ 371 Date: Jan. 3, 2013

(30) Foreign Application Priority Data
Jul. 8, 2010 (EP) 10168890.1

(51) Int. Cl. H01M 10/056; H01M 10/052; H01M 12/02; C01D 15/00

(52) U.S. Cl. CPC H01M 10/056; C01D 15/00; H01M 10/052; H01M 12/02
USPC 429/403; 423/301; 429/199; 429/338; 429/342; 429/331; 429/332

(57) ABSTRACT

LiPO₂F₂ is manufactured by the reaction of P₄O₁₀ with LiF forming a reaction mixture comprising LiPO₂F₂. To isolate pure LiPO₂F₂, the reaction mixture is extracted with water, organic solvents or mixtures thereof, and if desired, pure LiPO₂F₂ is isolated from the solution. The pure LiPO₂F₂ can be re-dissolved in suitable organic solvents, e.g. in fluorinated and/or non-fluorinated organic carbonates. Another aspect of the present invention is crystalline LiPO₂F₂. LiPO₂F₂ is suitable as electrolyte salt or as electrolyte salt additive for Li ion batteries, for lithium-sulfur batteries and for lithium-oxygen batteries.

The present invention claims benefit of European patent application No. 10168890.1 filed on Jul. 8, 2010 the whole content of this application being incorporated herein by reference for all purposes.

The present invention relates to a method for the manufacture of LiPO₂F₂ and to crystalline LiPO₂F₂.

LiPO₂F₂ is useful as electrolyte salt or additive for an electrolyte salt for lithium ion batteries. Thus, WO 2008/111367 discloses how to manufacture a mixture of LiPF₆ and LiPO₂F₂ from a halide other than a fluoride, LiPF₆ and water. The resulting salt mixture, dissolved in aprotic solvents, is used as an electrolyte solution for lithium ion batteries. EP-A-2 061 115 describes, as state of the art at that time, the manufacture of LiPO₂F₂ from P₂O₃F₄ and Li compounds, and, as invention, the manufacture of LiPO₂F₂ from LiPF₆ and compounds with a Si—O—Si bond, e.g. siloxanes.

Object of the present invention is to provide LiPO₂F₂ in a technically feasible manner. Another object oft he present invention is to provide LiPO₂F₂ which can easily be handled. These objects and other objects are achieved by the invention as outlined in the patent claims.

According to one aspect of the present invention, LiPO₂F₂ is manufactured by the reaction of P₄O₁₀ with LiF. The resulting reaction mixture comprises LiPO₂F₂. It is assumed that Li₃PO₄ is present in the reaction mixture as by-product according to the reaction equation

P₄O₁₀+6LiF→3LiPO₂F₂+Li₃PO₄

The molar ratio of LiF to P₄O₁₀ is preferably equal to or greater than 5:1. It is preferably equal to or lower than 10, more preferably, ≦8.

Preferably, the reaction is performed in the absence of water or moisture. Thus, the reaction may be performed at least for a part of its duration in the presence of an inert gas; dry nitrogen is very suitable, but other dry inert gases may be applied, too. The reaction can be performed in an autoclave or in other reactors. It is preferred to perform the reaction in apparatus made from steel or other materials resistant against corrosion, e.g. in reactors made of or clad with Monel metal.

The lithium fluoride applied is preferably comminuted, e.g. milled to obtain a higher contact surface between phosphoric acid anhydride and LiF. It is preferred to mix the reactants thoroughly. For example, this can be performed, preferably in the presence of dry inert gas, e.g. nitrogen, in a dry box or in a mixer, e.g. a mixer with three dimensional flow.

The reaction time is selected such that the desired degree of conversion is achieved. Often, a reaction time of 10 minutes to 5 hours gives good results.

The reaction temperature is preferably equal to or higher than 225° C., preferably equal to or higher than 250° C.

The reaction temperature is preferably equal to or lower than 325° C., preferably equal to or lower than 300° C.

If desired a reactor can be applied with internal heating or external heating.

The resulting reaction mixture is in solid form. If desired, it is comminuted, e.g. milled, to provide a larger contact surface if it is intended to dissolve constituents of it.

The LiPO₂F₂ formed can be isolated from the resulting reaction mixture, if desired. This can be achieved by dissolving it with solvents which preferentially dissolve LiPO₂F₂. Aprotic and protic organic and inorganic solvents are suitable, especially polar solvents. The preferred inorganic solvent is water. Organic protic or aprotic solvents can be used for the extraction, too.

Suitable protic organic solvents are alcohols. Alcohols with one, two or three hydroxy groups in the molecule are preferred. Methanol, ethanol, n-propanol, i-propanol, glycol and glycerine are preferred alcohols. Glycol alkyl ethers, e.g. diglycol methyl ether, are also suitable. Also acetone, in its tautomeric form, can be considered as protic solvent. Another highly suitable solvent for LiPO₂F₂ is dimethoxyethane. This solvent dissolves a great amount of LiPO₂F₂, but at most neglectable amounts of LiF.

Aprotic polar solvents are also very suitable for the extraction of LiPO₂F₂ from the reaction mixture. Preferably, the aprotic organic solvent is selected from the group of dialkyl carbonates (which are linear) and alkylene carbonates (which are cyclic), and wherein the term “alkyl” denotes preferably C1 to C4 alkyl, the term “alkylene” denotes preferably C2 to C7 alkylene groups, including a vinylidene group, wherein the alkylene group preferably comprises a bridge of 2 carbon atoms between the oxygen atoms of the —O—C(O)—O— group; ketones, nitriles and formamides. Dimethyl formamide, carboxylic acid amides, for example, N,N-dimethyl acetamide and N,N-diethyl acetamide, acetone, acetonitrile, linear dialkyl carbonates, e.g. dimethyl carbonate, diethyl carbonate, methyl ethyl carbonate, cyclic alkylene carbonates, e.g. ethylene carbonate, propylene carbonate, and vinylidene carbonate, are suitable solvents.

In the following table 1, some suitable solvents and their capability to dissolve LiPO₂F₂ are compiled.

TABLE 1
Solubility of LiPO₂F₂ in certain solvents

| | Solubility of LiPO₂F₂ |
|---|---|
| Solvent | [g/100 g solvent] |
| Diethyl carbonate | 0.4 |
| Dimethyl carbonate/propylene | 0.4 |
| carbonate (1:1 v/v) | |
| Acetonitrile | 2.8 |
| Dimethoxyethane | 37 |
| Acetone | 20 |

All these solvents are very bad solvents for LiF; accordingly, they are well suited to separate mixtures comprising LiPO₂F₂ and LiF. They can advantageously be used for purification purposes and as solvents or components of solvents in electrolyte solutions for Li ion batteries with the possible exception of acetone which is very suitable for purification purposes, but is not very suitable as solvent or solvent component in electrolyte solutions.

It is also possible to use mixtures containing water and one or more organic protic or aprotic solvents. It is preferred that the pH of the water used for extraction, and of water-containing organic solvents applied for extraction, of the LiPO₂F₂ formed in the reaction is selected such that undesired hydrolysis of LiPO₂F₂ is prevented. Especially, the pH is equal to or lower than 7 to prevent hydrolysis. It is preferred to keep the pH at a value of equal to or lower than 7 during the contact of LiPO₂F₂ formed with the water or the mixture of water and organic solvent or solvents.

Mixtures of water and protic solvents can be applied for the isolation of LiPO₂F₂, for example, mixtures of water and alcohols with 1, 2 or 3 hydroxy groups, e.g., mixtures of water and methanol, ethanol, isopropanol, n-propanol, glycol, glycerine or diglycol.

Mixtures of water and aprotic organic solvents, especially, polar aprotic solvents, can also be applied, for example, mixtures of water with one of the solvents mentioned above, e.g. with ethylene carbonate or propylene carbonate.

Of course, it also possible to apply mixtures which comprise water, one or more protic organic solvents and one or more aprotic organic solvents. For example, mixtures containing water, an alcohol like methanol, ethanol or i-propanol, and a nitrile, for example, acetonitrile, or propylene carbonate, can be applied.

The content of water in these mixtures is preferably between 1 and 99% by weight.

The extraction may be performed in a known manner, for example, by stirring the reaction mixture with the solvent (extractant) directly in the reactor, or after removing the reaction mixture from the reactor and optionally crushing or milling, in a suitable vessel, e.g. a Soxhlet vessel.

The liquid phase containing LiPO₂F₂ dissolved in the solvent can be separated from the non-dissolved constituents of the reaction mixture in a known manner. For example, the solution can be passed through a filter, or it can be decanted, or the separation can be effected by centrifugation. The solution of LiPO₂F₂ in water-free solvents is useful as such, e.g. as an additive for the manufacture of electrolyte solutions for lithium ion batteries.

If desired, the solution of LiPO₂F₂ can be subjected to a separation treatment to separate the solvent and to obtain pure solid LiPO₂F₂. This can be performed in a known manner. For example, the solution can be cooled to lower the solubility of the dissolved LiPO₂F₂, or the solvent can be removed by evaporation which may preferably be performed in a vacuum depending on the boiling point of the solvent or solvents.

The isolated LiPO₂F₂ can be used as additive for the manufacture of lithium ion batteries. It can also be used as additive for Li-sulfur batteries and for Li-oxygen batteries.

Isolated solid LiPO₂F₂ can be re-dissolved in any suitable solvent or solvent mixture, especially in at least one polar aprotic organic solvent to provide an electrolyte solution suitable for lithium ion batteries, lithium-sulfur batteries and lithium-oxygen batteries.

It has to be noted that water is undesired in lithium ion batteries, thus, water-free organic solvents are generally applied.

A solution of LiPO₂F₂ in propylene carbonate for example contains, under standard conditions (25° C., 1 Bara), up to about 3% by weight of LiPO₂F₂ relative to the total weight of the solution. In other solvents or solvent mixtures, the amount of LiPO₂F₂ which dissolves at a given temperature will vary but can easily be determined by simple tests.

An electrolyte solution for lithium ion batteries, lithium-sulfur batteries or lithium-oxygen batteries comprising LiPO₂F₂ will often contain another electrolyte salt. For example, LiPF₆, LiAsF₆, LiClO₄, LiCF₃SO₃, LiN(SO₂CF₃)₂, LiN(SO₂C₂F₅)₂, LiN(SO₂-i-C₃F₇)₂, LiN(SO₂-n-C₃F₇)₂, LiBC₄O₈ (“LiBOB”), or Li(C₂F₅)PF₃, can additionally be contained in the electrolyte solution. Preferably, LiPF₆ is additionally contained.

Besides LiPO₂F₂ and, optionally, other electrolyte salt or salts present, especially LiPF₆, the electrolyte solution for lithium ion batteries, for lithium-sulfur batteries or for lithium-oxygen batteries comprises one or more solvents. Solvents for this purpose, generally aprotic polar organic solvents, are known. Organic carbonates, especially dialkyl carbonates, e.g. dimethyl carbonate or ethyl carbonate, alkylene carbonate, e.g. ethylene carbonate, fluorinated solvents, e.g. mono-, di-, tri- and/or tetrafluoroethylene carbonate, are very suitable. Instead or additionally, the electrolyte solution may comprise any other desired solvents or additives, for example, lactones, formamides, pyrrolidinones, oxazolidinones, nitroalkanes, N,N-substituted urethanes, sulfolane, dialkyl sulfoxides, dialkyl sulfites, as described in the publication of M. Ue et al. in J. Electrochem. Soc. Vol. 141 (1994), pages 2989 to 2996, or trialkylphosphates or alkoxyesters, as described in DE-A 10016816. also, dimethoxyethane and acetonitrile are very good solvents for LiPO₂F₂, see above.

Alkyl carbonates with linear and branched alkyl groups and alkylene carbonates are especially suitable, for example, ethylene carbonate, dimethyl carbonate, methyl ethyl carbonate, diethyl carbonate, and propylene carbonate, see EP-A-0 643 433. Pyrocarbonates are also useful, see U.S. Pat. No. 5,427,874. Alkyl acetates, N,N-disubstituted acetamides, sulfoxides, nitriles, glycol ethers and ethers are useful, too, see EP-A-0 662 729. Often, mixtures of these solvents are applied. Dioxolane is a useful solvent, see EP-A-0 385 724. For lithium bis-(trifluoromethansulfonyl)imide, 1,2-bis-(trifluoracetoxy)ethane and N,N-dimethyl trifluoroacetamide were applied as solvent, see ITE Battery Letters Vol. 1 (1999), pages 105 to 109. In the foregoing, the term “alkyl” preferably denotes saturated linear or branched C1 to C4 alkyl groups; the term “alkylene” denotes preferably C2 to C7 alkylene groups, including a vinylidene group, wherein the alkylene group preferably comprises a bridge of 2 carbon atoms between the oxygen atoms of the —O—C(O)—O— group, thus forming a 5-membered ring.

Fluorosubstituted compounds, especially fluorosubstituted carbonates, lower the flame point and have a positive effect on the life cycle of the battery. Often, fluorosubstituted organic compounds are applied in the form of solvent mixtures with at least one further solvent which is preferably non-fluorinated. The at least one further non-fluorinated solvent is preferably selected from those solvents mentioned above. The non-fluorinated organic carbonates mentioned above are very suitable.

In solvent mixtures for lithium ion batteries, lithium-sulfur batteries and lithium-oxygen batteries, preferably, fluorinated carbonic esters which are selected from the group of fluorosubstituted ethylene carbonates, fluorosubstituted dimethyl carbonates, fluorosubstituted ethyl methyl carbonates, and fluorosubstituted diethyl carbonates are contained.

Preferred fluorosubstituted carbonates are monofluoroethylene carbonate, 4,4-difluoro ethylene carbonate, 4,5-difluoro ethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate; dimethyl carbonate derivatives including fluoromethyl methyl carbonate, difluoromethyl methyl carbonate, trifluoromethyl methyl carbonate, bis(fluoromethyl) carbonate, bis(difluoro)methyl carbonate, and bis(trifluoro)methyl carbonate; ethyl methyl carbonate derivatives including 2-fluoroethyl methyl carbonate, ethyl fluoromethyl carbonate, 2,2-difluoroethyl methyl carbonate, 2-fluoroethyl fluoromethyl carbonate, ethyl difluoromethyl carbonate, 2,2,2-trifluoroethyl methyl carbonate, 2,2-difluoroethyl fluoromethyl carbonate, 2-fluoroethyl difluoromethyl carbonate, and ethyl trifluoromethyl carbonate; and diethyl carbonate derivatives including ethyl (2-fluoroethyl) carbonate, ethyl (2,2-difluoroethyl) carbonate, bis(2-fluoroethyl) carbonate, ethyl (2,2,2-trifluoroethyl) carbonate, 2,2-difluoroethyl 2′-fluoroethyl carbonate, bis(2,2-difluoroethyl) carbonate, 2,2,2-trifluoroethyl 2′-fluoroethyl carbonate, 2,2,2-trifluoroethyl 2′,2′-difluoroethyl carbonate, and bis(2,2,2-trifluoroethyl) carbonate.

LiPO₂F₂ is preferably dissolved in at least one solvent selected from the group consisting of dimethoxyethane, acetonitrile, non-fluorosubstituted or fluorosubstituted organic carbonate selected from the group consisting of ethylene carbonate, dimethyl carbonate, methyl ethyl carbonate, diethyl carbonate, propylene carbonate, monofluoroethylene carbonate, 4,4-difluoro ethylene carbonate, 4,5-difluoro ethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

Ethylene carbonate, dimethyl carbonate, methyl ethyl carbonate, diethyl carbonate, propylene carbonate, monofluoroethylene carbonate, 4-(fluoromethyl)-ethylene carbonate, 4,4-difluoroethylene carbonate, 4,5-difluoroethylene carbonate and mixtures of two or more thereof, are especially preferred to dissolve LiPO₂F₂.

Carbonic esters having both an unsaturated bond and a fluorine atom (hereinafter abbreviated to as “fluorinated unsaturated carbonic ester”) can also be used as the carbonic ester. The fluorinated unsaturated carbonic esters include any fluorinated unsaturated carbonic esters that do not significantly impair the advantages of the present invention.

Examples of the fluorinated unsaturated carbonic esters include vinylene carbonate derivatives, ethylene carbonate derivatives substituted by a substituent having an aromatic ring or a carbon-carbon unsaturated bond, and allyl carbonates.

Examples of the vinylene carbonate derivatives include fluorovinylene carbonate, 4-fluoro-5-methylvinylene carbonate and 4-fluoro-5-phenylvinylene carbonate.

Examples of the ethylene carbonate derivatives substituted by a substituent having an aromatic ring or a carbon-carbon unsaturated bond include 4-fluoro-4-vinylethylene carbonate, 4-fluoro-5-vinylethylene carbonate, 4,4-difluoro-4-vinylethylene carbonate, 4,5-difluoro-4-vinylethylene carbonate, 4-fluoro-4,5-divinylethylene carbonate, 4,5-difluoro-4,5-divinylethylene carbonate, 4-fluoro-4-phenylethylene carbonate, 4-fluoro-5-phenylethylene carbonate, 4,4-difluoro-5-phenylethylene carbonate, 4,5-difluoro-4-phenylethylene carbonate and 4,5-difluoro-4,5-diphenylethylene carbonate.

Examples of the phenyl carbonates include fluoromethyl phenyl carbonate, 2-fluoroethyl phenyl carbonate, 2,2-difluoroethyl phenyl carbonate and 2,2,2-trifluoroethyl phenyl carbonate.

Examples of the vinyl carbonates include fluoromethyl vinyl carbonate, 2-fluoroethyl vinyl carbonate, 2,2-difluoroethyl vinyl carbonate and 2,2,2-trifluoroethyl vinyl carbonate.

Examples of the allyl carbonates include fluoromethyl allyl carbonate, 2-fluoroethyl allyl carbonate, 2,2-difluoroethyl allyl carbonate and 2,2,2-trifluoroethyl allyl carbonate.

Preferred electrolyte solutions comprise LiPO₂F₂ in an amount of 2 to 3% by weight and another lithium salt, preferably selected from the list of lithium salts mentioned above, such that the total concentration of the lithium slats in the electrolyte solution is about 0.9 to 1.1 molar (i.e., a total concentration 0.9 to 1.1 mol per liter). LiPF₆ is the preferred other lithium salt. Preferably, the electrolyte solution contains at least one of the fluorosubstituted carbonates mentioned above; monofluoroethylene carbonate is the preferred compound. It is preferably contained in an amount between 0.1 to 20% by weight of the total electrolyte solution. The balance to 100% by weight are preferably one or more optionally non-fluorinated solvents, especially ethylene carbonate, propylene carbonate, dimethyl carbonate, methyl ethyl carbonate, or diethyl carbonate.

Often, an electrolyte solution is provided comprising LiPO₂F₂ dissolved in a mixture comprising or consisting of at least one non-fluorinated organic carbonate and at least one fluorinated organic carbonate

Electrolyte solutions comprising LiPF₆, LiPO₂F₂, at least one fluorosubstituted carbonate selected from the group consisting of monofluoroethylene carbonate, 4,4-difluoroethylene carbonate, cis- and/or trans-4,5-difluoroethylene carbonate, and at least one non-fluorinated carbonate selected from the group consisting of dimethyl carbonate, methyl ethyl carbonate, diethyl carbonate, ethylene carbonate and propylene carbonate are especially preferred. These electrolyte solutions are suitable for lithium ion batteries, for lithium-sulfur batteries and for lithium-oxygen batteries. Dimethoxyethane and acetonitrile are also suitable solvents or component of a solvent to provide electrolyte solutions.

Such electrolyte solutions can be prepared by mixing the constituents in a vessel.

The advantage of the process of the invention is among others that pure crystalline LiPO₂F₂ can be obtained from cheap starting material, for example, when extracted from the reaction mixture with dimethyl carbonate or propylene carbonate as solvent and subsequent removal of the solvent, e.g. in a vacuum. Other solvents may yield an amorphous product.

Thus, crystalline LiPO₂F₂ is another aspect of the present invention. It is free of LiPF₆. It can be produced by the process of the invention or by other methods. It shows strong 2-Theta lines at 27.0 and 21.5. In the ¹⁹F NMR spectrum and the ³¹P NMR spectrum in D6 acetone solution, a doublet and a triplet are observed, respectively, at a chemical shift typical for PO₂F₂ anions. The crystalline LiPO₂F₂ is preferably free of LiF and preferably free of LiPF₆. Preferably, the content of chloride anions is equal to or lower than 1000 ppm, more preferably, equal to or lower than 100 ppm and even equal to or lower than 15 ppm. The term “preferably free of LiF” preferably denotes a content of LiF equal to or lower than 0.1 g per 100 g of the LiPO₂F₂. The term “preferably free of LiPF₆” preferably denotes a content of equal to or lower than 1 g, preferably equal to or lower than 0.1 g, more preferably, especially preferably equal to or 1 lower than 0.01 g of LiPF₆ per 100 g of LiPO₂F₂.

Should the disclosure of any of the patents, patent applications, and publications that are incorporated herein by reference conflict with the present description to the extent that it might render a term unclear, the present description shall take precedence.

The following examples will describe the invention in further detail without the intention to limit it.

### EXAMPLE 1

### Synthesis and Isolation of LiPO₂F₂

P₄O₁₀ (100 g; 0.35 mol) and freshly crushed LiF (3 mol) were given into a steel reactor having a lid, heated therein to a temperature of about 300° C. and kept at that temperature overnight. The reactor was brought to ambient temperature, was then opened, and the solids contained therein were crushed to smaller particles. The particles were given into a Soxhlet vessel and extracted with dimethyl carbonate. From the combined solutions, the solvent was removed by evaporation in a rotary evaporator, and the resulting solid was subjected to analysis by XRD, F-NMR and P-NMR.

### EXAMPLE 2

### Synthesis and Isolation of LiPO₂F₂

Example 1 was repeated by applying P₄O₁₀ and LiF in a molar ratio of 1:6. The starting materials were mixed in a dry box, then mechanically mixed in a Turbula® mixer with three dimensional flow for a few minutes, then transferred into the steel reactor, the lid was closed, and the reactor was heated for three hours in an oven at 300° C. The resulting solid was crushed, milled and then extracted in the Soxhlet apparatus for 24 hours. Thereafter, the solvent was removed in a Rotavapor® at 60° C. and around 100 mBar.

### EXAMPLE 3

### Synthesis and Isolation of LiPO₂F₂

Example 2 was repeated, but the extraction time was extended to 48 hours.

Analytical data of the crystalline LiPO₂F₂ produced:
XRD:2-Theta values: 21.5 (strong); 22.0; 23.5; 27.0 (strong); 34.2; 43.2
¹⁹F-NMR (470.94 MHz; solution in D-acetone): −84.25 ppm (doublet, the 2 lines at −83.3 ppm and −85.2 ppm, coupling constant 926 Hz)
³¹P-NMR (202.61 MHz; solution in D-acetone): −19.6 ppm (triplet, the 3 lines at −12.3 ppm, 16.9 ppm and 21.5 ppm; coupling constant 926 Hz).

Melting point: a melting point cannot be determined because the compound decomposes at temperatures above about 350° C.

For comparison: for HPO₂F₂ (the corresponding free acid; hydrolysis product of LiPF6, further comprising H₂PO₃F, measured in a mixture of propylene carbonate and dimethyl carbonate, with a few drops of water), a doublet at −83.3 ppm with a coupling constant of 975 Hz was reported for the ¹⁹F-NMR spectrum, and a triplet at −21.6 ppm with a coupling constant of 975 Hz in the ³¹P-NMR spectrum was reported in the literature.

### EXAMPLE 4

### Electrolyte Solution for Lithium Ion Batteries, Lithium-Sulfur Batteries and Lithium-Oxygen Batteries

23 g of LiPO₂F₂, 117 g of LiPF₆, 50 g monofluoroethylene carbonate (“FIEC”) and propylene carbonate (“PP”) are mixed in amount such that a total volume of 1 liter is obtained. The resulting solution contains 0.77 mol of LiPF₆ and 0.23 mol LiPO₂F₂. Thus, the amount of lithium compounds is about 1 mol per liter and thus corresponds to the concentration of lithium salts commonly used for the batteries, especially lithium ion batteries.

### EXAMPLE 5

### Synthesis and Isolation of LiPO₂F₂ Using Dimethoxyethane as Extractant

Example 1 is repeated, but dimethoxyethane is applied as a solvent. Due to the extremely high solubility of LiPO₂F₂ and the very low solubility of LiF, the extraction can be performed very fast with a relatively low amount of dimethoxyethane. The solution of LiPO₂F₂ in dimethoxyethane is subjected to a vacuum treatment to remove the solvent under very smooth conditions.

### EXAMPLE 6

### Synthesis and Isolation of LiPO₂F₂ Using Acetonitrile as Extractant

Example 1 is repeated, but acetonitrile is applied as a solvent. Due to the e high solubility of LiPO₂F₂ and the very low solubility of LiF in acetonitrile, the extraction can be performed very fast with a relatively low amount of acetonitrile. The solution of LiPO₂F₂ in acetonitrile is subjected to a vacuum treatment to remove the solvent under very smooth conditions; alternatively, due to the high purity of the LiPO₂F₂ dissolved in acetonitrile, the solution could directly be applied to produce a battery electrolyte solvent.

### EXAMPLE 7

### Synthesis and Isolation of LiPO₂F₂ Using Acetone as Extractant

Example 1 is repeated, but acetone is applied as a solvent. Due to the very high solubility of LiPO₂F₂ and the very low solubility of LiF, the extraction can be performed very fast with a relatively low amount of acetone. The solution of LiPO₂F₂ in acetone is subjected to a vacuum treatment to remove the solvent under very smooth conditions. The low boiling point of acetone allows for a very fast but nevertheless smooth isolation of the LiPO₂F₂.

1. A method for the manufacture of LiPO₂F₂ comprising a reaction of P₄O₁₀ with LiF to form a reaction mixture comprising LiPO₂F₂.

2. The method of claim 1 wherein the molar ratio of LiF to P₄O₁₀ is equal to or greater than 5.

3. The method of claim 1 wherein the molar ratio of LiF to P₄O₁₀ is equal to or lower than 10.

4. The method of claim 1 wherein the reaction is performed at a temperature equal to or higher than 250° C.

5. The method of claim 4 wherein the reaction is performed at a temperature equal to or lower than 300° C.

6. The method of claim 1 wherein LiPO₂F₂ is isolated from said reaction mixture with at least one solvent selected from the group consisting of water, organic protic solvents, and aprotic organic solvents.

7. The method of claim 6 wherein a solvent selected from the group consisting of water and a mixture containing water and a protic or aprotic organic solvent is applied.

8. The method of claim 7 wherein said solvent selected from the group consisting of water and said water containing mixture has a pH of equal to or lower than 7.

9. The method of claim 6 wherein an aprotic polar organic solvent is applied.

10. The method of claim 9 wherein the solvent is selected from the group consisting of saturated organic carbonates, unsaturated linear organic carbonates, and cyclic organic carbonates.

11. The method of claim 6 wherein the solvent is selected from the group consisting of dialkyl carbonates, alkylene carbonates, dimethoxyethane, acetone, and acetonitrile.

12. The method of claim 6 wherein said solution of LiPO₂F₂ dissolved in said solvent is subjected to a separation treatment to isolate LiPO₂F₂.

13. The method of claim 12 wherein the isolated LiPO₂F₂ is re-dissolved in at least one polar aprotic organic solvent to provide an electrolyte solution suitable for lithium ion batteries, lithium-sulfur batteries and lithium-oxygen batteries.

14. The method of claim 13 wherein LiPO₂F₂ is dissolved in at least one non-fluorosubstituted or fluorosubstituted organic carbonate selected from the group consisting of ethylene carbonate, dimethyl carbonate, methyl ethyl carbonate, diethyl carbonate, propylene carbonate, monofluoroethylene carbonate, 4,4-difluoro ethylene carbonate, 4,5-difluoro ethylene carbonate, 4-fluoro-4-methyl ethylene carbonate, 4,5-difluoro-4-methyl ethylene carbonate, 4-fluoro-5-methyl ethylene carbonate, 4,4-difluoro-5-methyl ethylene carbonate, 4-(fluoromethyl)-ethylene carbonate, 4-(difluoromethyl)-ethylene carbonate, 4-(trifluoromethyl)-ethylene carbonate, 4-(fluoromethyl)-4-fluoro ethylene carbonate, 4-(fluoromethyl)-5-fluoro ethylene carbonate, 4-fluoro-4,5-dimethyl ethylene carbonate, 4,5-difluoro-4,5-dimethyl ethylene carbonate, and 4,4-difluoro-5,5-dimethyl ethylene carbonate.

15. The method of claim 14 wherein LiPO₂F₂ is dissolved in a mixture of at least one non-fluorinated organic carbonate and at least one fluorinated organic carbonate to provide said electrolyte solution.

16. Crystalline LiPO₂F₂.

17. The crystalline LiPO₂F₂ of claim 16 having strong 2-Theta values at 21.5 and 27.0 in the XRD spectrum.

18. The crystalline LiPO₂F₂ of claim 16, being essentially free of LiF.

19. The crystalline LiPO₂F₂ of claim 16, being essentially free of chloride anions.
